(19) United States
(12) Patent Application Publication
(10) Pub. No.: US 2013/0060576 A1
(43) Pub. Date: Mar. 7, 2013

(54) Systems and Methods For Enabling Telemedicine Consultations and Patient Referrals

(71) Applicants: Kevin Hamm, Rocklin, CA (US); Tamara E. Sibson, Reno, NV (US)

(72) Inventors: Kevin Hamm, Rocklin, CA (US); Tamara E. Sibson, Reno, NV (US)

(21) Appl. No.: 13/598,537

(22) Filed: Aug. 29, 2012

Related U.S. Application Data
(60) Provisional application No. 61/528,636, filed on Aug. 29, 2011.

(51) Int. Cl. G06Q 50/22

(52) U.S. Cl. 705/2

(57) ABSTRACT

Systems and methods are provided for locating an on-call doctor, specific to a patient's needs, who is readily available for a live confidential patient consultation using a network enabled communication device with a digital camera and microphone. The system facilitates customized matching of patients with doctors to provide higher quality and faster delivery of medical evaluation, diagnosis, and treatment. The systems and methods transmit results through a secure connection and manage a referral process whereby a referring doctor refers a patient to another provider, laboratory, facility, or store for a particular procedure, order, analysis, or care. The referrals may be based on specialties and availability. The system relates particularly to the fields of medicine, where doctors can perform online consultations and provide a diagnosis, treatment recommendations, recommendations for further analysis, triage and/or provide follow up on-call care.

### CROSS-REFERENCE TO RELATED APPLICATION

This application claims priority to U.S. Provisional Application No. 61/528,636, filed Aug. 29, 2011, the contents of which are incorporated herein by reference in their entirety.

### BACKGROUND

1. Field of the Invention

The present invention is generally related to telemedicine and more particularly related to facilitating live patient-doctor consultations via a digital medium. More specifically, this invention is directed toward using a network accessible system to match a patient with a doctor and schedule a telemedicine consultation using personal communication devices communicatively coupled through a secure/encrypted point to point connection via a data communication network.

2. Related Art

Medical providers are struggling with the increased costs to practice medicine and decreasing health plan reimbursements. New business models are emerging as a result and medical providers are exploring ways to increase income to stay in practice and see more patients without compromising quality of care.

Expenses for emergency department (“ED”) visits in 2003 were higher than for ambulatory visits to hospital outpatient department or office-based settings. In particular, the median expense for an emergency department visit of $299 was more than twice as large as the median expense for a hospital outpatient department visit ($131) and nearly five times that for an office-based visit ($63). Emergency Medicine constitutes a medical specialty in which patients requiring immediate medical attention seek consult from an emergency medicine physician for diagnosis and management of acute and urgent aspects of illness and injury. Emergency physicians are tasked with seeing a large number of patients, and either treating their illnesses or arranging for disposition—either admitting them to the hospital or releasing them after treatment. Emergency physicians can be specialized in the following: Emergency Medical Services, Hospice and Palliative Medicine, Medical Toxicology, Pediatric Emergency Medicine, Sports Medicine, and Undersea and Hyperbaric Medicine.

It is often said that emergency medicine physicians treat “anyone, anything, anytime.” A valid ED visit is by definition a “life threatening” situation. Everything else is considered non-emergent and can be handled outside the ED. Many patients come to the E.D. because it's always open. In 2005, the EMPATH study, a national survey of emergency-department patients, suggested that patients with non emergency cases may seek the high-tech, high-quality E.D. care just because it's there and available 24/7. The most common symptoms that lead a patient to utilize emergency medicine are: stomach pain, cramps, and spasms; chest pain and related symptoms; fever; cough; headache; shortness of breath; back symptoms; vomiting; sore throats; and various accidents. The fact is, many people don't have a good way to judge whether a headache or fever is a true medical emergency.

If a patient has a minor illness or injury, and the emergency department isn't crowded, the patient may wait 1 to 2 hours to see a physician. In 2007, U.S. emergency patients waited an average 4 hours and 5 minutes in the emergency department, a 5-minute increase from the previous year (Press Ganey Associates, 2009). Patients requiring care of a certain nature would likely prefer on-call care, which achieves the same result as a visit to the E.D. and is more efficient, alleviates the burden on the U.S. healthcare system, and helps to drive healthcare costs down.

Exorbitant health insurance premiums. Employers pay benefits for the majority of the working population. Rising insurance premiums force high deductible health plans transferring financial burden to the patient, or cause coverage to lapse or cancel contributing to the high rate of uninsured people. Rising insurance premiums force the reduction or elimination of benefits, driving individuals into consumer-driven health plans (typically high-deductible), which promote private pay and freedom of choice. Patients are more responsible with this freedom when invested, and participate in the experience and outcome. Uninsured persons can access quality affordable healthcare, but now so can fully insured individuals who participate in consumer-driven models.

Managed Care restrictions. Patients who are members of managed care organizations often look outside their dedicated provider networks to seek second opinions or alternative care outside their limited plan design and/or network.

Specialized care for particular medical conditions that either by nature of disease or by need for confidentiality warrant a patient to locate a certain doctor and engage a confidential patient consultation in the privacy and convenience of their home.

Existing provider networks are dysfunctional on-line networks, not consolidated, unreliable, incomplete, lack methods to maintain up-to-date information, and lack the ability to arrange for an on-call doctor on an immediate basis.

Labor and Economy lend to more people being home. As of 2011, about 34 million people work from their residence occasionally, reports Forrester Research, a technology and market research company. They predict that approximately 63 million people will work remotely by 2016. Whether this is because they want to save money on gas or the fact that companies are becoming increasingly comfortable with their employees telecommuting, people increasingly want to accomplish important tasks, such as grocery shopping and paying bills from the comfort of their home. In 2010, 17.3% of the GNP was devoted to healthcare, which translates to more than $2.5 trillion.

Home health supplies and equipment. Access to information helps make new products and services available to the general population. This includes accessibility to home health equipment and supplies which can be facilitated through on-call care.

Therefore, what is needed is a system and method that overcomes these significant problems found in the conventional systems as described above.

### SUMMARY

Accordingly, to address the problems found in the conventional systems, described herein are systems and methods that provide solutions to enable telemedicine consults between patients and desired physicians based on the availability of the physicians. The systems and methods allow delivery of the same high-quality standard of care that is provided in an office setting while also saving time, money, increasing efficiency and increased access to healthcare professionals.

The system includes one or more consult servers that maintain one or more databases of physicians. Patients register with the consult server and login to search for a desired physician, for example, the patient's primary physician or a specialist in a particular field. When the desired physician is identified, if the physician is available, the consult server establishes a rich multimedia session between the patient and the physician. Patient information can be summarized and provided to the physician in advance of and during the multimedia session. After the consultation, the physician will document the medical encounter in an approved electronic medical record, which can be stored and accessed later. The medical progress note will be sent to the patient via a secure email. Alternatively, any treatment plan or prescription can be provided to the patient and also recorded and stored for later delivery to a primary care physician or consolidation with the patient's medical history or other electronic health record(s). Payment to the physician may also be managed by the consult server. Payment can be made directly by the patient or through an insurance plan to which the patient belongs.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a network diagram illustrating an example system for enabling telemedicine consults according to an embodiment of the invention;

FIG. 2 is a block diagram illustrating an example consult server according to an embodiment of the invention;

FIG. 3 is a block diagram illustrating an example patient device according to an embodiment of the invention;

FIG. 4 is a block diagram illustrating an example physician device according to an embodiment of the invention;

FIG. 5 is a flow diagram illustrating an example process for enabling a telemedicine consult according to an embodiment of the invention;

FIG. 6 is a block diagram illustrating a method of matching a patient with a doctor and scheduling an appointment, according to an embodiment of the invention;

FIG. 7 is a block diagram of a method of conducting a telemedicine consultation, according to an embodiment of the invention;

FIG. 8 is a block diagram of a method for presenting educational information to a patient in a patient referral system, according to an embodiment of the invention; and

FIG. 9 is a block diagram illustrating an example wired or wireless processor enabled device that may be used in connection with various embodiments described herein.

### DETAILED DESCRIPTION

Certain embodiments disclosed herein provide for systems and methods for enabling telemedicine consultations. For example, one method disclosed herein allows for a patient to identify a desired physician through a database search and immediately establish a rich multimedia consultation session with the physician if the physician is available. The rich multimedia consultation session allows the physician to diagnose the patient and prescribe a treatment protocol, which can be communicated to the patient during the rich multimedia session and also after the session, for example by delivery of a prescription by facsimile or other electronic means. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

Video and Audio Consultations

Technology allows for the transmittance of real time audio-video data via a communication device that has a digital camera and a microphone. For example, a standard smartphone, such as the iPhone® 4, is capable of HD video (720 p) with audio and features a 5-megapixel still camera with an LED flash that produces VGA-quality photos and video at up to 30 frames per second. Its 3.5-inch (diagonal) widescreen has a resolution of 960-by-640 pixels at 326 ppi. It supports the following video formats: H.264 video up to 720 p, 30 frames per second, Main Profile level 3.1 with AAC-LC audio up to 160 Kbps, 48 kHz, stereo audio in .m4v, .mp4, and .mov file formats; MPEG-4 video, up to 2.5 Mbps, 640 by 480 pixels, 30 frames per second, Simple Profile with AAC-LC audio up to 160 Kbps per channel, 48kHz, stereo audio in .m4v, .mp4, and .mov file formats; Motion JPEG (M-JPEG) up to 35 Mbps, 1280 by 720 pixels, 30 frames per second, audio in ulaw, PCM stereo audio in .avi file format.

Based on this technology, images and video captured by the communication device are sufficiently reliable to replace the need for a bricks and mortar encounter with a medical provider. The medical industry does not shy away from using projected images to help patients, and this process is along the same lines as an orthopedic surgeon using an arthroscope to view the inside of a patient's knee to help diagnose and treat knee problems. However, most telemedicine solutions start at around $30,000 for the equipment on both ends. The present system greatly reduces costs by allowing patients to use consumer grade communication devices as the telemedicine equipment. Advantageously, many consumers already own such equipment in the form of smartphones or computers with webcams.

The Internet is a common vehicle for private and confidential, secure transactions dealing with health information or financial information. In cases in which two parties of a conversation are unable to physically be in the same location, both individuals and organizations have become comfortable and familiar with utilizing videoconferencing via the Internet to simulate face to face interactions. Videoconferencing, a set of interactive telecommunication technologies which allow two or more locations to interact via two-way video and audio transmission simultaneously, has been available commercially since the early 1970s when AT&T introduced their Picturephone technology. However, it has only recently become available to average consumers. Notably, the use and portrayal of telemedicine in television shows, such as popular TV medical drama “House,” highlights the trend toward growing public acceptance of telemedicine. And the actual use of telemedicine is on the rise.

The present system for enabling telemedicine consults provides a technical solution for a convenient and rapid ability to locate a qualified on-call medical provider through custom search and engagement in a confidential face to face patient consultation from anywhere in the world where a data communication network exists. The system provides a technical solution for the ability to evaluate, treat, transmit results, and manage the referral process. The system can be applied to all areas of medicine, where a doctor uses real-time audio and video conferencing with patient history for diagnostics including, but not limited to: internal medicine, family practice, pediatrics, dermatology, pathology, radiology, trauma, ophthalmology, ear, nose, and throat diseases, etc. The system allows a physician status module to locate an on-call medical provider that matches the patient's needs. The physician is readily available for live confidential patient consultations using a communication device with real-time audio and video technologies to facilitate evaluation, diagnosis, and treatment.

The system takes advantage of rich media such as MMS or teleconferencing combined with a network communication infrastructure and a camera enabled communication device (e.g., a mobile telephone with a digital camera). A communication device is used to transmit data (e.g., a digital image or a video and audio stream) from the patient to the qualified medical provider.

In one embodiment, the patient receives a unique personal identification number related to each unique randomized patient encounter for privacy and confidentiality purposes. The patient receives first-hand medical information related to the on-call care. The patient receives first-hand medical information related to the order, recommendation, or treatment plan to follow on-call care. The medical information includes a possible diagnosis, treatment recommendations, and recommendations for follow up. The patient has ongoing access to the results and the referred to party/entity receives specific instructions.

In one embodiment, the patient who requires medical attention launches the application. The patient enters a search criterion (e.g., based on perceived symptoms) which returns a list of qualified medical providers. The selection process comprises of a method to match profile criteria to query criteria. The patient is presented with a series of questions to produce a list of qualified medical providers to address the unique medical need. The patient selects from the list which includes the option to visit a medical provider in person or via video conference with a physician on-call who is immediately available to see the patient. The patient can choose either “first available” or “specify further.” There are signals to indicate the wait time and there are controls that limit waiting time by minimum and maximum periods. The patient can choose to wait a minimum period, a maximum period, return at a later time, schedule a time with a preferred physician, or redirect to another qualified physician on-call.

The patient must complete several required forms, disclose medical history and provide consent prior to medical evaluation. The patient has the option to use a patient liaison (help desk) to register confidential patient information while waiting. For example, the patient liaison may be accessed via a video or text chat service, a telephone call, or the like. The patient provides contact information and payment information to request consultation and at the point in which the transaction clears, the on-call physician is notified. The on-call physician launches the secure application on her communication device to engage patient consultation. The patient and the on-call physician conduct a confidential telemedicine consultation. There is a process to validate patient information and there are further agreements.

In one embodiment, the application allows for the visit to be completely recorded and documented. The resulting recording and medical information can be securely stored and all or portions of it are transmitted to the on-call physician, her office, the patient's insurance company or any number of alternative or additional destinations and all or portions of the resulting recording and medical information can also be stored in the form of electronic health data, EOB, medical notes, orders, prescriptions, and other storage formats critical for seamless Health Information Exchange (“HIE”) amongst varying providers.

The system can be used for other fields of medicine as well as other professions entirely. In particular the invention relates to a system which facilitates the selection of a qualified service provider for a particular desired need and enabling face to face communication between the consumer and a qualified on-call service provider to address the needs of the consumer.

The operation of each of these embodiments is described further herein in detail in accordance with further embodiments and relevant figures. In these further embodiments, a system sorts and lists information, sends and retrieves information, collects and stores data (such as email, name, address, phone, etc.), handles communication, handles dropped communications, sees images, accesses a database, provides a user interface, produces outputs, provides a device with a processor, a memory which is arranged to carry out the functions of the system, permits use of an email address and provides the ability to search and filter results.

Definitions

The following definitions are provided for terms used to describe the systems and methods herein.

On-call care: The service in which a licensed medical professional will be available to discuss patient and family health concerns or questions.

Telemedicine: The remote diagnosis and treatment of patients by means of telecommunications technology.

Immediate: Occurring at once within specified limitations

Face-to-Face: The time a health care provider interacts with a patient.

Help Desk: A service providing information and support in both English and Spanish to the users of the online telemedicine network and used to determine proper specialty or and back ground on doctor(s) requested.

Fulfillment: the outcome concluding a face-to-face telemedicine consultation; the fact that the patient was seen by a health care provider.

Live Chat: software that enables the Help Desk to receive and respond to text communication specifically to provide online assistance to users of the online telemedicine network. May also facilitate voice communication between help desk and users.

Telemedicine Consultation System

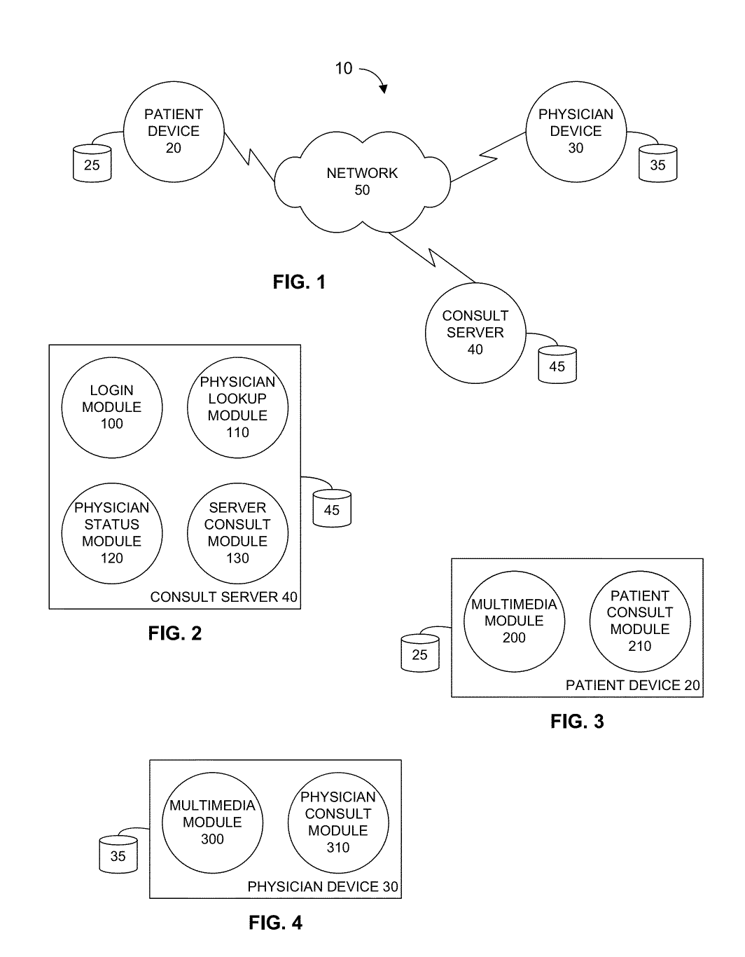

FIG. 1 is a network diagram illustrating an example system 10 for enabling telemedicine consults according to an embodiment of the invention. In the illustrated embodiment, the system 10 comprises one or more patient devices 20, one or more physician devices 30 and one or more consult servers 40. These network devices are communicatively coupled via a communication network 50. Each of the network devices are also configured with a data storage means, 25, 35 and 45, respectively.

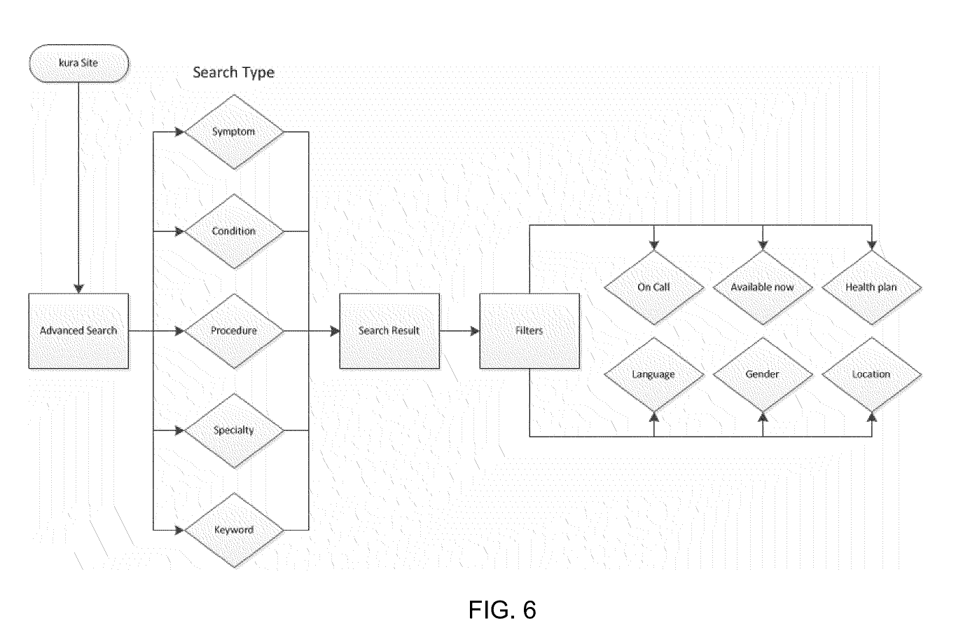

The patient device 20 and physician device 30 can be any sort of processor enabled communication device that is capable of communicating over network 50 with other devices. For example, the communication devices can be in the form of a personal computer, laptop, personal digital assistant, tablet computer, smartphone, music player, or any other such device that is capable of establishing a rich multimedia session with another communication device over the network 50. The consult server 40 is can also be any sort of processor enabled communication device that is capable of communicating over the network 50 with other devices. The consult server, however, does not necessarily need to be able to participate in a rich multimedia session with another communication device. An example processor enabled communication device that can be used for the patient device 20, physician device 30 or consult server 40 is described later with respect to FIG. 6.

FIG. 2 is a block diagram illustrating an example consult server 40 according to an embodiment of the invention. In the illustrated embodiment, the consult server 40 comprises a login module 100, a physician lookup module 110, a physician status module 120 and a server consult module 130.

The login module 100 is configured to validate patients and physicians that login to the server 40. In one embodiment, patients and physicians each login to the server 40 prior to being able to establish a rich multimedia session for a telemedicine consult. The login module 100 is also configured to register new patients and physicians and establish accounts for these users of the server 40. In one embodiment, the login module 100 collects necessary medical background information, insurance information, and payment information from a new patient as part of registering the new patient and creating an account for the new patient on the server 40. Additionally, the login module 100 may also collect necessary information from a physician prior to validating and approving the physician for inclusion in the database of physicians.

The physician lookup module 110 is configured to manage and maintain a database of physicians stored in an accessible data storage area such as data storage area 45. Data storage area 45 can be local or remote to the server 40, but is preferably local. The database of physicians comprises a vast amount of information about individual physicians and practice groups including specialties and locations. Additional information including patient feedback and other social media commentary may also be included. The physician lookup module 110 is also configured to allow patients to search for and evaluate potential physicians the patient may desire to consult with. The physician lookup module 110 also interfaces with a list of physician schedules by specialty to assure the patient will not wait longer than 30 minutes for the patient's selected doctor. The physician lookup module 110 also tracks what doctors are available and logged in so that the patient can continue to hold, choose an alternative Physician, or be redirected to the help desk. Accordingly, a patient may browse through physician profile information and social media commentary information about a plurality of physicians in order to identify one or more desired physicians to consult with.

The physician status module 120 is configured to maintain a current status for the physicians in the physician database. In one embodiment the current status may be a binary choice of “currently available” and “not available” so that a patient browsing through the physician database knows if the physician is presently available for a telemedicine consult. In alternative embodiments, additional status indicators may be included, for example, a physician may be taking on new regular patients or may be available in two hours or two days or the physician status may include a calendar that includes certain days and times during which the physician will be available for a telemedicine consult. Advantageously, a patient may be able to schedule a telemedicine consult with a desired physician in this manner.

The server consult module 130 is configured to establish a telemedicine consult session between the patient device 20 and the physician device 30. In one embodiment, the server consult module 130 works cooperatively with a patient consult module and a physician consult module that are resident on the patient communication device and the physician communication device, respectively. The telemedicine consult session is preferably a real time audio and video conference session but any rich multimedia session that allows the physician to receive sufficient information (e.g., text, audio, video) to evaluate a patient to make a diagnosis may comprise a telemedicine consult session. In one embodiment, the server consult module 130 establishes the rich multimedia session in a fashion that screens the personal contact information of the patient and the physician from the other party to the rich multimedia session. This screening advantageously allows patients and physicians to use their existing personal communication devices for the rich multimedia session without providing the personal contact information to the other party. This is particularly helpful for physicians who do not wish to be contacted by a patient on their personal communication devices outside the context of a dynamically arranged or scheduled telemedicine consult.

The server consult module 130 is also configured to record the rich multimedia session and store the session in the data storage area 45. The server consult module 130 is also configured to send all or portions of the rich multimedia session (e.g., just the pertinent information) to the patient, the patient's primary physician, an insurance company, an electronic health record management system, pharmacy, or other designated recipient. The server consult module 130 is also configured to deliver prescriptions from the physician to the patient. For example, the physician may write a prescription, scan the prescription and upload it to the server 40 and the server consult module 130 delivers the prescription to the patient. In one embodiment, prescriptions may be delivered via email, facsimile, or any other digital, electronic, or physical means.

FIG. 3 is a block diagram illustrating an example patient device 20 according to an embodiment of the invention. In the illustrated embodiment the patient device 20 comprises a multimedia module 200 and a patient consult module 210. The multimedia module 200 is configured to capture images (still and video) and sound for a rich multimedia session such as a digital video conference. The multimedia module 200 is also configured to present images and sound for a rich multimedia session such as a digital video conference.

The patient consult module 210 is configured to establish and carry out a rich multimedia session with another communication device such as a physician communication device. In one embodiment, the patient consult module 210 works cooperatively with a server consult module to establish and carry out the rich multimedia session. The patient consult module 210 is also configured to allow the patient to login to the consult server and search for available physicians and schedule future telemedicine consultations sessions and edit the patient profile that stores information about the patient including preferences and criteria and other data.

FIG. 4 is a block diagram illustrating an example physician device 30 according to an embodiment of the invention. In the illustrated embodiment the physician device 30 comprises a multimedia module 300 and a physician consult module 310. The multimedia module 300 is configured to capture images (still and video) and sound for a rich multimedia session such as a digital video conference. The multimedia module 300 is also configured to present images and sound for a rich multimedia session such as a digital video conference.

The physician consult module 310 is configured to establish and carry out a rich multimedia session with another communication device such as a patient communication device. In one embodiment, the physician consult module 310 works cooperatively with a server consult module to establish and carry out the rich multimedia session. The physician consult module 310 is also configured to allow the physician to login to the consult server and edit the physician profile that stores information about the physician including medical specialties and other profile and marketing data that may be viewed by potential patients when searching for a physician.

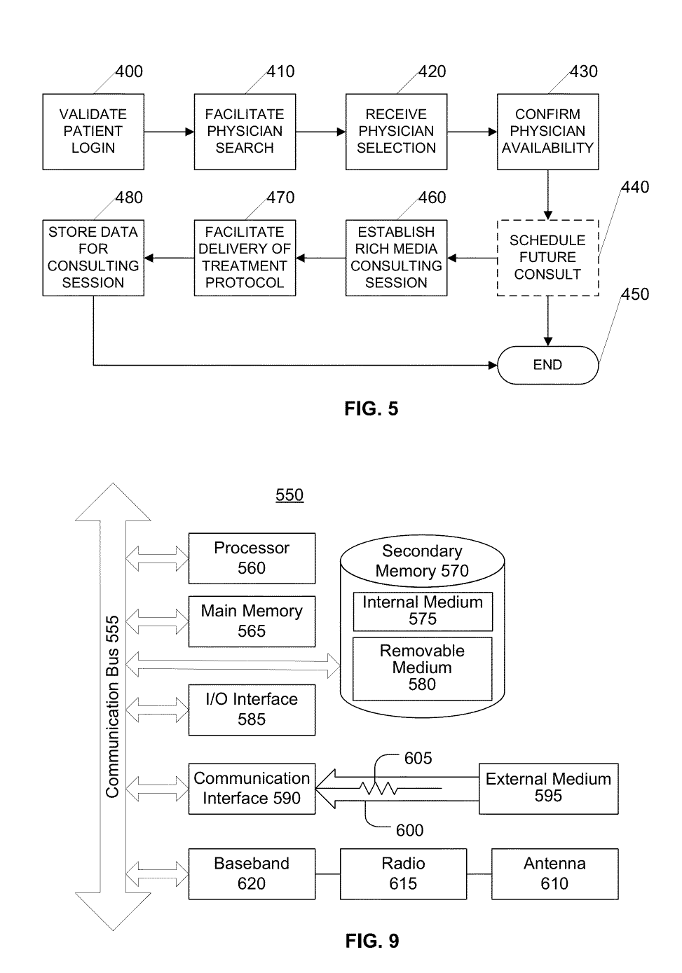

FIG. 5 is a flow diagram illustrating an example process for enabling a telemedicine consult according to an embodiment of the invention. In one embodiment, the process may be carried out by the system 10 previously described with respect to FIG. 1. Initially, in step 400 the patient login is validated. If the patient is a new patient, then a patient registration process is carried out after which the patient login is validated. Next, in step 410 the consult server facilitates a physician search by the patient. The patient may search by a variety of criteria and the patient may also establish and store certain criteria in the patient's profile that are automatically used by the search system to filter the results. For example, the patient may only want a female doctor and this criterion can be stored in the patient profile (along with other criteria) so that all searches automatically include this criterion or so that all search results are automatically filtered by this criterion. Once the patient has conducted the search in step 410, the consult server receives a physician selection from the patient in step 420. Next, in step 430 the consult server determines the current availability of the physician for a telemedicine consultation.

In one embodiment, availability may include more than the immediate availability (e.g., within the next 30 minutes) of the physician. For example, it may also include general availability such as accepting new patients or available to schedule a telemedicine consultation at some future time. A calendar of available future times may also be accessible to the patient to view and schedule a future telemedicine session. For a future session, the consult server advantageously may place a reminder on the calendar of the patient and may also initiate the rich multimedia session at the appointed time to establish the telemedicine consult between the patient and the physician. Accordingly, in optional step 440 a future consultation may be scheduled.

If the physician is currently available for a telemedicine consultation, in step 460 a rich multimedia session is established between the communication device of the patient and the communication device of the physician. The rich multimedia session may be a video conference such as a Facetime® call or it may be a voice call enhanced by still images transmitted from the patient to the doctor as needed. At the end of the telemedicine consultation, in step 470 the consult server facilitates delivery to the patient of any treatment protocol including any prescriptions provided by the physician. Delivery may be made by electronic means or facsimile or any other means. Finally, in step 480 the consult sever stores a portion of or all of the data from the telemedicine consultation session.

In one embodiment, the stored data may include an entire transcript of the rich media session and any treatment protocol and prescriptions provided by the physician. The recorded session/stored data may also include demographic information about the patient and the physician, for example, information obtained the patient or physician user profile that is stored on the consult server. In this fashion, a complete record of the telemedicine session can be maintained for the benefit of the patient and the physician. Advantageously, all or portions of the stored record of the telemedicine consultation session may be provided by the consult sever, for example to an electronic health record storage facility, a primary care physician for the patient, an insurance company, or any other entity designated by the patient or physician.

### EXAMPLE EMBODIMENT

In an example embodiment, the patient is directed toward registration/login on the consult server and asked for their username/password. If the patient is a first time user, the patient fills out the patient registration form before continuing. After successfully logging in, the patient searches for a doctor though the physician lookup module. Once an available on-call doctor is chosen, a real time telemedicine consult is established between the patient device and the device of the chosen doctor.

When the patient is searching for an available doctor, the patient conducts a physician search and is notified that this physician is either online or offline (available or unavailable). If the doctor is offline, the patient returns to the physician search to try again. Once the patient chooses an online physician, the online physician can accept the request if she does not already have too many patients waiting for a live telemedicine consultation. Alternatively, the doctor can also deny the request. In one embodiment, the consult server may set the status of an on-call doctor to “offline” if the doctor has too many patients already queued up for a live telemedicine consultation. If the doctor denies the request, the patient returns to the physician search. If the doctor accepts the request, the patient begins the live telemedicine consultation using the patients communication device. Advantageously, a message is displayed and/or played through a speaker to the patient informing the patient that if the patient believes they have a live threatening condition contact 911 or seem immediate emergency assistance.

Below is an outline of an example embodiment:

If patient is first time user:

Payment information and request for Explanation of Benefits (EOB) to be mailed.

Patient Registration

1. Age
A. Under 18
   1. Consent and attestation from a parent or legal guardian.
   2. On-line form required to mirror form of a regular office visit

B. 18+

1. Name

2. Gender

3. Date of Birth

4. Address

5. Cellular Telephone Number

6. SSN

7. Enter any necessary 3^{rd} party account information required for multimedia services (they will need to enter an Apple ID, Skype ID, etc.)

Forms Patients Need to Sign

1. Consent for Telemedicine

2. Attestations

A. The consumer does NOT have medi-care or medical as his/her primary insurance

B. The consumer states that he/she is 18 years or older

3. Email Policy

4. Privacy policy

5. Notice that schedule 2 medications will be prescribed for 48 hours ONLY

A. List of Schedule II drugs under the Controlled Substances Act for the United States. Required findings for drugs to be placed in this schedule:

1. The drug or other substance has a high potential for abuse.

2. The drug or other substance has a currently accepted medical use in treatment in the United States or a currently accepted medical use with severe restrictions.

3. Abuse of the drug or other substances may lead to severe psychological or physical dependence.

4. Opiates, Stimulants, Depressants, Cannabinoids, Immediate precursors

At this point new patients receive their unique username/password. All non-first time users automatically start at this point.

Search doctor by:

1. Name

2. Area

3. Wildcards accepted in search strings

4. Keyword

Filter doctor by:

1. Procedure

2. Illness/injury/Condition

3. Symptom (majority)

4. Health Plan (Note regarding HSA repayment requirements)

5. Provider

6. Gender

7. Language Spoken

8. Primary Specialty

9. Sub/Secondary Specialty

10. Featured Procedures

11. Licensure & Certifications

12. Education

Patient Requests a Consult

On-call lights:

1. Green=no patients

2. Orange=consulting (up to 2 patients may be in the queue)

a. Worst case, a patient only waits 30 minutes (this is configurable and can be set by the patient in the patient profile)

3. Red=select a different physician

Doctor Responds/Patient Consultation

Doctor is now in Telemedicine Group EMR which is critical to maintain congruency in patient care and HIE between disparate systems and various health systems.

1. Doctor is “pinged” on cell phone as a text message that he/she has a patient waiting

2. Doctor enters the secure app to see consult

3. Doctor requests to begin the consult

4. Doctor uses secure app to begin face-to-face time with patient

5. Patient validation (Name, Birthday, etc.)

6. Consult occurs

In case of lost connection application sends number to phone for help desk and Doctor receives a display of caller's number.

a. Patients may use the home health kit, which is a set of equipment/supplies (such as a thermometer, blood pressure cuff, otoscope, etc.) that assist the doctor in diagnosing the illness/injury

7. Doctor diagnoses illness/injury

8. Doctor determines treatment/makes notes and documents the consult in 15 minutes

a. Rx fill to pharmacy

b. Medical notes/records

c. Referral to another doctor

d. Suggestion for follow-up

e. Order Diagnostic, MRI

f. Medical note to employer, school, etc.

g. Order blood work for basic labs, drug screening, etc.

h. Application confirms receipt delivery of RX

Patient either contacts help desk or Doctor calls patient.

At the end of the consult, the patient may be prompted to rate her experience, satisfaction and recommendation. The patient rating may be accomplished via a text message or other post consultation paper or digital process.

Information collected in data base used for improvements, grants, marketing.

Patient Referral System

Described herein is an approach to the doctor/patient relationship that incorporates selection and filtering processes which accommodate personal criteria in order to find an appropriate doctor and schedule a consultation.

In one embodiment, a system is provided for a patient referral network which receives incoming patients and patient profile information and uses this information to quickly find an appropriate doctor for a specialized, interactive virtual consultation or a physical, in-person consultation. Referrals of patients to doctors may originate from many sources, such as fellow doctors, healthcare providers, employers and patients themselves. Referrals are strong generators of new business, as the referral is usually based on specialized knowledge of the doctor or patient that makes the patient a good fit for that particular doctor. The system provides access to secure health information that is used to promote direct, convenient access to healthcare by focusing on the relationship between the patient and doctor and helping the patient find a doctor who is appropriate for that patient and is available for a consultation—either in-person or via telemedicine, as has already been described.

In one embodiment, the system first uses a processing unit, such as the consult server 45 in FIG. 1, to execute a methodology for determining the availability of doctors and helping patients match up with an appropriate doctor. Variables such as specialty, time, location and other factors may be used to determine an appropriate referral for a patient. The system is designed to incentivize doctors to create referral groups that span a variety of practice areas in order to increase referrals from all doctors in a particular referral group. This model of patient intake may provide two layers of filtering by first going through a selection process, then an availability process and then a referral team process. The selection process may encompass a patient searching for specific doctors, only entering symptoms and asking the system to find an appropriate doctor, or even simply requesting any doctor so that an initial consultation will occur before any attempt at a diagnosis is made. The selection process may include selecting of a doctor by a patient using patient profile information. After the selection process, a second layer of filtering is applied which selects the best-matched doctor from the selection process that is also available for a consultation. In a further step, the doctor may have a referral team of other doctors who can then be used to determine which specific doctor will conduct a consultation with the patient.

The patient referral system facilitates patient referrals (generated from various sources such as doctors, health plans, employers, other patients, etc) and facilitates the delivery of quality, affordable health information through an online patient/doctor meeting. Physician referrals are highly valued in the business of healthcare. Of the types of referrals that exist (patient, fellow doctor referrals, health plan referrals), fellow doctor referrals have considerably more weight with patients in terms of credibility and efficacy.

The system utilizes a network of doctors selected based on unique criteria in order to provide a plurality of services via a telemedicine appointment. The system creates a network of “on-call” doctors that spans all types of medical specialties, allowing a patient to find a doctor particularly suited for their needs and immediately schedule an appointment with that doctor to conduct a live meeting using a digital medium.

The patient referral system provides a single site represented as a graphical user interface (GUI) and delivered as a web-based application or local software product which provides a patient with improved healthcare services and a doctor with increased opportunities for delivering their specialized services to a broader base of potential patients.

There are no online lists today that work in a meaningful or productive way, and there are no consolidated lists today that work well and are not restricted. There is no ability to find a doctor by personal patient criteria—doctors are instead located and selected by their location, name, speciality and affiliated hospital or healthcare provider. Furthermore, once a doctor is selected, the patient's online experience ends, as there are virtually no services provided online past the simplistic doctor selection tools.

The embodiments of the system described herein have characteristics of search engines, diagnostic tools and managed care platforms, but additionally provide access to interactive educational forums and telemedicine in order to build direct relationships with doctors via a digital medium. The system improves access to and flow of secure health information.

In a typical patient doctor transaction, an insurance provider or a managed care body is typically in the middle of the transaction (managing the care, controlling payments and reimbursements and even the flow of information). This pay-for-performance model (managed care model) is the mechanism for which a premium is earned, and it affects how money and information is distributed in the healthcare environment. The insurance intermediary cost is borne by the doctor and patient.

In contrast, the patient referral system works without the insurance retailer, providing a more efficient delivery of medical services from a doctor and patient which is less restrictive.

The systems and methods for generating patient referrals described herein provide a unique methodology for identifying an appropriate match between a patient and a doctor. Additional methodologies provide for establishing on-call schedules for doctors conducting consultations and selecting the doctors based on patient profile information related to the patient's specific health needs. The system provides for facilitating collegiality and networks among the doctors within the system, aiding in the creation of referral circles based on expertise and common experience. The system creates unique criteria for establishing an environment conducive to patient referrals between doctors, healthcare providers, employers and patients based on unique expertise of doctors within the system, helping the doctors generate a following and reputation for service and particular medical specialties.

The system incorporates and considers variables such as specialty, time, location, and other factors in determining appropriate referrals of doctors for inquiring patients. In addition, the patients can provide specific medical and health information relating to a problem or an overall sense of their health in order to customize the patient referral system even further, allowing for better matching of patients with specific doctors.

In one embodiment, the patient referral system provides methods for obtaining and delivering quality health and medical information. A patient may create an individual health profile with their own medical and health information which can then be stored within the system, accessed by patients, doctors and transferred to appropriate healthcare providers and other relevant parties within the system as needed. For example, the patient profile information can be transmitted to a doctor for a consultation with a patient, and the consultation itself can be conducted over a network, also constituting the transmission of patient profile and medical information. In one embodiment, the system can stream content to the patient at the beginning of a consultation so the patient can occupy themselves by viewing content—similar to a virtual magazine rack at a doctor's office. The streamed content may be customized based on the reasons the patient has provided for their visit. The patient can also customize their inquiries during an initial waiting period to see information on the medical or health issues they are consulting the doctor on. The patient profile is also used to match patients with doctors by finding doctors with profile information that is considered to match with patient profile information.

In one embodiment, the process of selecting doctors to join the network is also the subject of unique methodologies. A training methodology with certain credentialing requirements and other selection criteria may be implemented.

In one embodiment, a network of doctors is provided to produce patient referrals. Healthcare providers use networks of doctors to promote their health plans by “selling” the doctors on the list. However, the healthcare provider referral system no longer works for several reasons: 1) it's homogenous (most doctors are on most lists which means health plans do not produce value to its constituents; 2) healthcare networks provide limited online technology, as profits are driven from in-person visits and care; 3) patients mostly find doctors through patient referrals—such as word of mouth or private advertising by the doctor outside of a health plan; and 4) patients don't select a doctor by specialty alone anymore—in the information age, doctor selection is driven by far more personal patient criteria.

The healthcare industry might be the only economic sector where online networks are not involved in any meaningful way. The patient referral system provided herein combines the unique approach of allowing selection by personal patient criteria to produce a set of relevant results, and then providing another filter of logic that selects the best doctor matching that personal patient criteria that is also available “on-call” for an immediate consultation using web-based interactive technologies. The consultation aspects also provide for selecting another doctor within a particular referral network if a preferred doctor is unavailable. The patient referral system incorporates a selection and filtering process that accommodates personal criteria for the purpose of consulting a doctor, and which provides incentives for internal, secondary referrals between doctors and other parties within the system.

FIG. 6 is a block diagram illustrating a method of matching a patient with a doctor and scheduling an appointment, in accordance with one embodiment of the invention. A patient starts off at an interactive graphical user interface (GUI) provided on a website, on a local computer with proprietary software or perhaps a web-based application, and then may perform a search for a doctor. The search may be a basic search for a doctor (not shown), or an advanced search may be performed with one or more search types related to the patient profile or procedures needed, such as symptoms, conditions, procedures, specialties or keywords, although this list is not exhaustive by any means. Search results are then obtained, and a filter is applied to filter the search results by doctors which are available for consultations based on additional criteria. The filter may select doctors based on whether they are “on-call” for a consultation in the near future, available immediately for a consultation such as a video conference, whether the doctor is in a certain health plan that the patient belongs to, languages spoken, gender and even location. Again, this list of filters is not exhaustive. Customized scheduling interfaces may be provided in order to schedule the consultation between the patient and the doctor, and additional features may be available to the doctors in order to allow for advanced scheduling features between a doctor's practice or a group of doctors in a group practice.

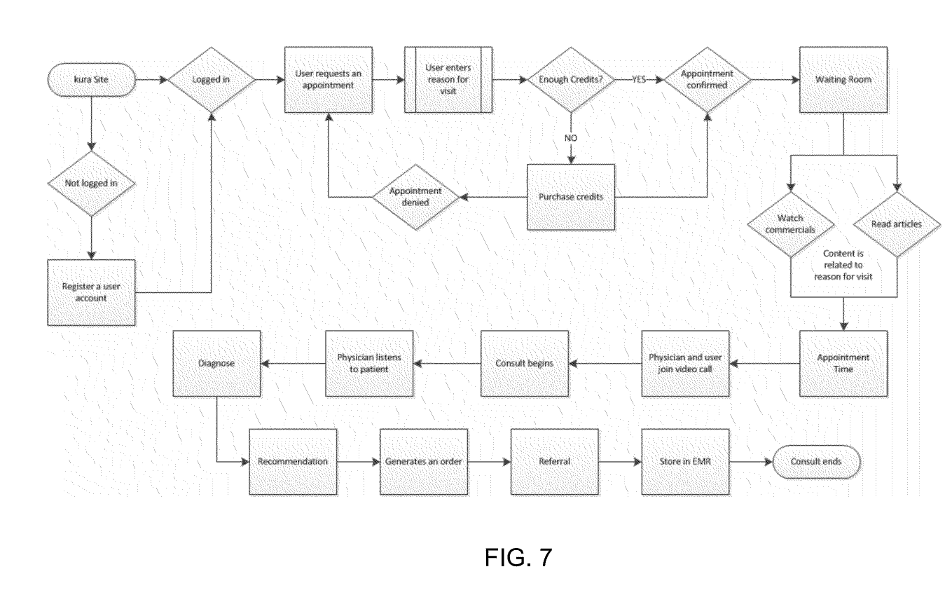

FIG. 7 is a block diagram of a method of conducting a telemedicine consultation, in accordance with one embodiment of the invention. This method may be considered a “virtual waiting room,” where a patient is placed immediately in advance of an online consultation with a doctor. The patient will begin at the GUI, provide login credentials as needed, request an appointment, enter reasons for their visit, and purchase credits to pay for the appointment, and confirm the appointment with the doctor, all through the GUI interface. The patient may then be placed in a virtual waiting room where they can be provided with content that is related to the reason for their visit. For example, relevant health topics and tips based on the reason for their consultation may be provided, or commercials for products, treatments and medication may be provided that relate to the reason for their visit. At their scheduled appointment time, the doctor will initiate the consultation by starting a video or audio call and beginning the consultation. The doctor and patient will then complete the consultation, at which point the doctor may provide a diagnosis and recommendations for treatment, including prescribing medication or medical devices. In one embodiment, the doctor may provide a referral to another doctor, such as a specialist, if the doctor believes it is needed. The entire consultation, including the recommendations, prescriptions, etc. may be recorded electronically in a patient's electronic medical record (EMR).

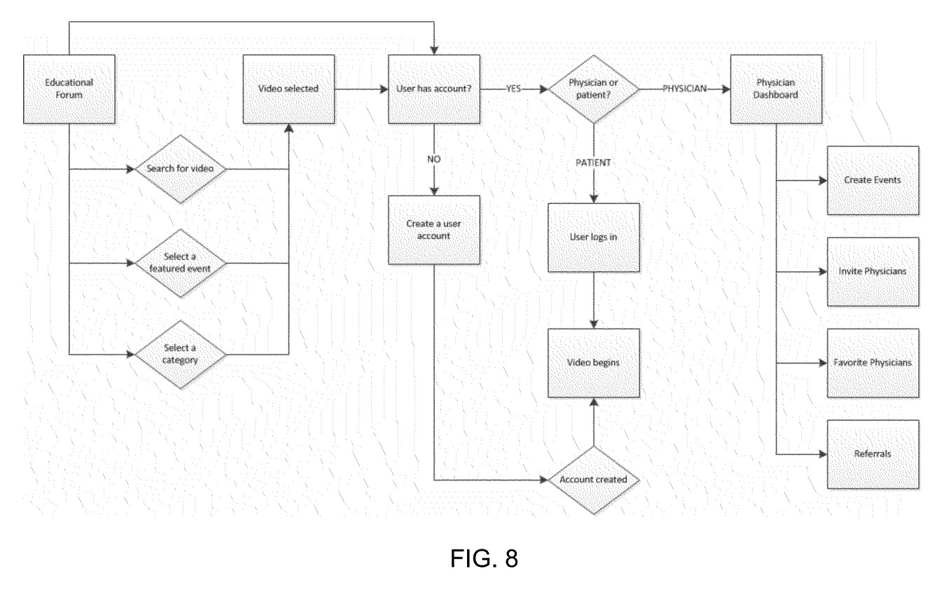

FIG. 8 is a block diagram of a method for presenting educational information to a patient in a patient referral system, in accordance with one embodiment of the invention. In this embodiment, the patient is provided with an educational forum via the GUI described above, and the patient can use the forums to search for videos, select an event (such as an online discussion about a particular medical topic) or select a category for further education. Once an item is selected, the patient may be prompted to enter login credentials, after which the video or selected item is provided to the patient. In one embodiment, the educational information is a video conference with the doctor where one or more participants—doctors or patients, can listen in and interact with the doctor giving the presentation. In addition, while the presentation is being given, the patients or doctors listening to the presentation can access separate content—such as news articles, journals, pictures, video, etc. and submit this separate content to the presenter and the group listening to the presentation to initiate further discussion. A library of content may be available to the patients or doctors that can help to spur discussion and debate about a particular medical topic being discussed. The doctor is also provided with options in the educational forum so they can create the videos, events and other categories of medical information to provide to patients. Doctors may be provided with an overall dashboard showing all of the content they have created on the system, which they can use as a tool to recruit new patients to their practice. Doctors can also create their own referral networks by selecting favorite doctors within the network, inviting doctors to join their referral network, or generally requesting referrals on their dashboard (which may be visible to other doctors).

FIG. 9 is a block diagram illustrating an example wired or wireless system 550 that may be used in connection with various embodiments described herein. For example the system 550 may be used as or in conjunction with a patient device, physician device, or consult server as previously described with respect to FIGS. 1, 2, 3 and 4. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In one embodiment, the system 550 includes a camera (not shown) that is capable of capturing still and/or video image data as part of a rich multimedia session. For example, the camera may allow the system 550 to send high quality still images to data storage and/or a peer communication device. The camera may also allow the system 550 to send high quality video to data storage and/or a peer communication device. In this fashion, the system 550 is capable of establishing and implementing a rich multimedia session with another communication device over a communication network.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that were previously described with respect to FIGS. 2 and 3.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A technical system for enabling telemedicine consultations, the system comprising:
a patient communication device comprising a non-transitory computer readable medium, a processor and a patient consult module configured to establish a rich multimedia session with a physician communication device;
a physician communication device comprising a non-transitory computer readable medium, a processor and a physician consult module configured to establish a rich multimedia session with a patient communication device;
a consult server communicatively coupled with the patient communication device and the physician communication device via a communication network, the consult server comprising a non-transitory computer readable medium, a processor and a server consult module configured to provide physician search data to a patient communication device, receive a physician selection from a patient communication device, and establish a rich multimedia session between the patient communication device and a physician communication device for the selected physician.

2. A computer implemented method for enabling telemedicine consultations, where one or more processors are programmed to perform steps comprising:
validating patient login information;
facilitating a physician search by the patient;
receiving a selection of a physician from the patient;
confirming the physician is available for a telemedicine consultation;
establishing a rich media session between a communication device associated with the patient and a communication device associated with the physician, wherein the rich media session comprises the telemedicine consultation;
delivering results of the telemedicine consultation to the patient.
